(19) United States
(12) Patent Application Publication
(10) Pub. No.: US 2019/0099879 A1
(43) Pub. Date: Apr. 4, 2019

(54) ROBOT SYSTEM, METHOD FOR CONTROLLING A ROBOT SYSTEM, AND PROCESSING SYSTEM

(71) Applicant: KBee AG, Munich (DE)

(72) Inventor: Sami Haddadin, Hannover (DE)

(73) Assignee: KBee AG, Munich (DE)

(21) Appl. No.: 16/083,192

(22) PCT Filed: Mar. 8, 2017
(86) PCT No.: PCT/EP2017/055499

§ 371 Date: Sep. 7, 2018

(30) Foreign Application Priority Data
Mar. 8, 2016 (DE) 10 2016 002 812.2

(51) Int. Cl. B25J 9/00; G05B 19/418; B25J 9/16

(52) U.S. Cl. CPC B25J 9/0093; G05B 19/4182; B25J 9/1679; B25J 9/1633; G05B 19/4189

(57) ABSTRACT

The invention relates to a robot system, to a corresponding method, and to a processing system, wherein, along a process line, which is formed by guide rails, or on a conveyor belt, objects or workpieces are optionally moved or transported on carrier devices having gripping elements. The robot arm removes the objects from the process line by pulling or pushing the objects from a plane or surface of the process line into a working chamber compliantly, i.e., in a non-rigid manner by means of force control, wherein the objects are positioned and oriented in the working chamber by means of guiding elements. After the processing of the objects in the working chamber, the objects are pushed or pulled back onto the process line by means of the robot arm. The process line can comprise passive, non-driven rollers or the like instead of an actively driven conveyor belt, wherein the robot arm nudges or pushes the objects in order to transport the objects.

This invention relates to a robotic system, a method of controlling a robotic system and a processing system or work station using a robotic system.

Robotic systems are known in a wide variety of designs. So-called “Pick and Place” robotic systems are used in particular in the area of production lines or process lines, in which objects, e.g. for processing/machining, sorting and/or packaging purposes, are continuously guided between individual work stations or production machines via active or passive conveyor belts.

These have at least one robot arm, for example, which moves the objects or products to be processed or sorted from one position to another. The robot arm, at the end of which is a gripper or end effector, removes the object from a container, for example, and uses it to load a machine tool or the like, or removes the object from such a machine tool and feeds it to another container for transport purposes.

The automated flow or non-interrupted processing devices or processing systems known from the state of the art for objects moving in them by means of a conveyor belt are always associated with high investment costs, since corresponding, partially driven feed and discharge devices must be provided for the objects in the periphery thereof. In addition, such systems are characterised by low flexibility in terms of processing different types of products or objects.

If it is now desired to arrange a “Pick and Place” robotic system in the area of such a classic flow/non-interrupted processing device, e.g. for the purpose of packaging or palletizing objects, several problems arise. “Pick and Place” robotic systems as such are designed to perform monotonous applications with relatively high speed and precision. However, this requires that the conveyor means of such a flow processing device must be precisely timed with regard to the material flow, which of course requires a high investment in terms of accuracy and programming, but still offers a certain susceptibility to errors.

Due to the precisely specified timing, the robotic systems can therefore only be “taught” with a moving assembly line or conveyor, which makes the teach-in process as such more complex for the robotic system as a whole and thus increases setup costs. During operation of such a flow processing device, the synchronisation of the moving conveyor and the movement of the robotic system requires a so-called “conveyor tracking”, in which a robot arm can follow the conveyor belt, for which additional control means, sensors and, in addition to the teach-in of the robotic system, appropriate control programming of the entire system is required.

In the case of passive flow/non-interrupted processing devices, e.g. rollers arranged on corresponding slopes, over which the objects can move independently, the passive material flow must always be initiated from the outside, e.g. by a person or an additional technical device. This makes clocking and thus synchronisation with the movement of the robotic system more difficult.

The “Pick and Place” robotic systems known from the state of the art serve exclusively for removing objects or equipping machines, containers or packaging with these objects. They therefore require precise parameterization of the positions of objects, machines, packaging, etc. This also means that the objects, containers, carrier devices or similar moving on the associated process line must always be in exactly the right relative positions to the robotic system. The “Pick and Place” procedure therefore proves to be very error-prone in the event of unforeseen position deviations.

In principle, the exact determination of the positions of the moving objects on the one hand and the exact assignment to the robot or its effector, both in relation to stationary states and the movements to be carried out by these, on the other hand, requires a multitude of sensors, accompanied by corresponding, sometimes complex evaluation electronics. Only sensors can detect any positional deviations of the objects with which the robot is to interact, in any form whatsoever, without errors being clearly excluded. Conversely, sensors that detect the movement and, if necessary, the type of objects to be machined, require these objects to be guided strictly congruently, preferably linearly, along the given paths or process lines of a corresponding flow processing device or a machining system comprising at least one robot. In return, this requires a correspondingly high-precision design of the processing devices, conveyor belts and the like for the objects or also the containers or carrier devices for these objects. The different positions and position sequences of the objects or the carrier devices that are set within such a complete system within the framework of locomotion on the one hand and the processing steps to be carried out on the other can only be approached by position-controlled or position-regulated robotic systems. Of course, this considerably increases the programming effort in connection with the distribution of the sensors used. Robotic systems cannot be taught in such an environment in a simple way.

In addition, state of the art robotic systems designed to process objects in the area of a designated working space, such as assembly robots, are not capable of transporting these objects simultaneously between different positions due to their kinematics, dimensions or design and the effectors used. This is usually also due to the fact that the working space is functionally and spatially decoupled from the process line along which the objects to be processed move independently or by means of driven conveyors. The nominal working space is often located in the immediate vicinity of a production or sorting machine.

In order to improve automation in the sorting and/or production of products and thus shorten the cycle times associated with cost savings, it is a general effort in manufacturing technology to increase the variety of products and variants per production line. Several different objects should preferably be moved along a process line, which can also be subjected to different machining processes by one or more machining devices, depending on the process line. However, this requires a certain flexibility and adaptability of the devices involved, in particular the robotic systems used in such flow processing devices, which are intended for transporting or processing the objects.

Furthermore, the “Pick and Place” robotic systems known from the state of the art are not designed for further processing steps, such as the assembly of small parts, the assembly or insertion of components, material handling, measuring or testing, or the like. For highly automated production lines, however, for reasons of economy, it may be desirable to combine several of these processing steps.

On this basis, the invention has the objective of creating a robotic system and a method for controlling such a robotic system, which can be positioned in the area of a process line and can be flexibly used there in such a way that the intended application or working process for objects intended for use on the process line can be simplified while further improving automation. In addition, the invention has the objective of providing a processing system in which a robot or a robotic system in the aforementioned sense is used, whereby the positioning of the objects for the intended processing operations to be carried out on them is to be further simplified. In this context, the effort for planning and designing the paths and process lines for the moving objects is to be further minimized, and the use of sensors that may be prone to errors is to be largely avoided or even completely excluded.

These objectives are solved with a robotic system according to claim 1, with a method for controlling such a robotic system according to claim 6 and with a machining/processing or working system using an invention-related robotic system according to claim 12.

The invention therefore relates to, in a first aspect, a robotic system comprising at least one robot arm and a control unit for controlling the movement of the robot arm, comprising at least one effector, the robotic system being positionable in the region of a process line along which an object or a carrier device on which the object is arranged is movable, the control unit and the robot arm being configured such that
the robot arm can interact with the object in the area of a working space assigned to the robotic system such that the effector processes the object, and
the robot arm can guide the object or the carrier device into and/or out of the working space by means of the effector, the robotic system having compliance control and the control unit further being designed such that the robot arm moves the object or carrier device relative to at least one guide means of the working space for guiding the object or carrier device such that the object or carrier device is automatically positioned in the correct position relative to the robotic system for machining or handling.

For the purposes of this invention, compliance control means impedance control, indirect force control, force control or a combination of these control measures.

In this context, the robot's compliance according to the invention should preferably be such that the guidance of the object leads to a convergence of motion, as explained below.

Furthermore, the compliant behaviour shall be configured such that the forces occurring between the object and the guide means during guidance by the robot do not cause damage to the object.

Consequently, this invention is aimed at robotic systems that actively interact with an object by means of an effector. In the context of the invention, it must be understood that the robotic system can also be intended and designed to enter into an active interaction with the object, which goes beyond pure transportation, as for example in the “pick and place” robotic systems known from the state of the art, or beyond simple assembly steps of assembly robots, which usually always repeat themselves in the process in the same way.

Due to the fact that the robot arm not only “processes” the object in the working space provided for this purpose, but also actively and independently guides the object or a carrier device intended for the object into the working space with the aid of the at least one guide means and positions it there accordingly before the effector of the robot arm interacts with the object for the intended purpose and/or out of this working space after completion of the processing, if necessary, with the aid of the at least one guide means, the invention is accompanied by the advantage that the processing operations intended for this purpose can be considerably simplified and accelerated. The cycle times can be shortened considerably.

In this context, the invention is aimed, but not exclusively, at lightweight robotic systems. Such robotic systems have a torque sensor and/or force sensors in each joint of the robot arm. This force/torque sensor system allows a programmable compliance of the robotic system, so that simpler, less maintenance and thus cheaper tools or effectors can be used.

Compliance control, also known as impedance or stiffness control, is in principle an indirect force control of the joints of the robotic system, in which it behaves, for example, as a linear spring-mass damper system in relation to the externally applied or acting torques and forces. In other words, the desired contact force to be exerted by a gripper on an object, for example, occurs indirectly via a “desired behavior” in the case of an existing contact and is not specified, as would be the case with conventional force control, in which a contact force to be exerted by the robotic system or a torque to be exerted is specified taking a defined control target into account.

In one embodiment, the robotic system is configured such that the working space is provided in the area of the process line and the control unit and the robot arm are configured such that the robot arm can guide the object or the carrier device along the process line between two spaced-apart guide means by means of the effector. The process line, for example a passive conveyor belt, is preferably arranged in the immediate vicinity of the robotic system. In principle, such a “passive” conveyor belt consists only of a flat track, the course of which is determined by two guide means in the form of guide surfaces or walls bounding this track laterally. The objects or the carrier devices are guided through the robot arm between these guide walls, which act as perimeter walls so to speak. The robot with integrated compliance essentially only applies the force required to move the objects, either pull or push, while the objects are guided through the guide means and the robot with its several axes follows the direction of movement induced by the guide means on the objects in a compliant manner, with a corresponding clearance being provided between the guide surfaces and the objects or the carrier devices. In this way it is possible, according to the invention, that the object or the carrier device, driven by the robot, can follow a substantially linear process line as well as any curved process line.

Preferably, the guide surfaces are designed so that they have low coefficients of friction. This would be of fundamental advantage for the guidance of the objects, but is not absolutely necessary, since the friction coefficients and thus the friction pairings between the guide surfaces and the objects moving along them are taken into account in an appropriate manner when designing the compliance control of the robotic system to be used as a basis.

In another embodiment, the robotic system is configured such that the working space is provided outside the process line and the control unit and the robot arm are configured such that the robot arm can guide the object or the carrier device from the process line into the working space between two mutually converging guide means and/or out of these guide means and thus from the working space back to the process line. The robot arm can remove the object or the carrier device from the process line and feed it to the working space for further processing steps, which are carried out by the robot arm or by an effector at its end. After completion of the intended work steps, the robot arm returns the object or carrier device back to the process line, which may be an active conveyor belt, for example, which then automatically conveys the processed object further.

The converging guide means can be designed in the form of two funnel-like guide surfaces converging for a final machining position for the object. The robot positions the object between the two guide surfaces and pulls or pushes it in the direction of the end position, with the guide surfaces surrounding the object further and further and finally centering it. According to the invention, this is only possible with a correspondingly compliant behaviour, so that no excessive contact forces between the object and the guidance will be created.

According to the invention, it is particularly preferred that the robot arm is designed in such a way that it does not lift or place the object or carrier device between the various positions, as for example a “pick and place” robot arm for removal or placement purposes would do, but instead pulls the object or carrier device on a plane or surface, either along the plane or surface of the process line and/or the plane or surface of the working space, or pushes it over this plane or surface. The respective planes do not necessarily have to form a common plane, but can deviate from each other to a certain extent. This is possible because the robotic system, according to the invention with its inherent programmed compliance and/or in combination with a corresponding force control, allows irregular surfaces to be run off.

Regardless of the type of effector the robot arm carries at its end with which it interacts with or processes the object, the invention allows the control system and the robot arm to be configured such that the robot arm, preferably with the effector, simply engages the object or carrier device, for example laterally, to further push the object or carrier device by applying a slight thrust force.

Alternatively, the control unit and the robot arm are designed in such a way that the robot arm can apply a pull and/or thrust force to the object or to the carrier device by means of the effector.

In a special embodiment, the robot arm has a gripper as an effector, which is also intended to interact with the object, for example to equip the object with further components, whereby the gripper also serves and is designed to actively grip or retract the object or carrier device and accordingly pull it along the process line into the working space by applying a corresponding light pull force.

In this context, it is also possible, according to the invention, that the guide means are formed of four tapering walls, which form a kind of funnel into which the robot inserts the object from above, whereby the guiding is made to the final position for the object through the funnel walls. In this way, assembly processes, e.g. the insertion of an object in a holder or receptacle provided for this purpose, can be considerably simplified in terms of programming.

When carrier devices are used, they may contain elements designed to engage the gripper, such as handles, eyelets, protrusions or the like.

The effector arranged on the robot arm can be designed in such a way that it interacts with the object without contact, such as a camera which is moved over the object for testing purposes.

However, this can also be an effector that comes into contact with the object, for example a measuring pin or a gripper that is to insert components into the object.

Also conceivable is an effector that is designed as a tool and can physically change the object, for example a soldering iron or a tool that serves to fasten components.

Irrespective of the design of the effector or the intended use of the effector, according to the invention it can always be used to actively guide the object or its carrier device between defined positions in the area of the process line.

A major advantage of the robotic system according to the invention is therefore that it determines the timing or clocking of the machining/working process itself. This eliminates the need for a constantly automated conveyor belt and for tracking, i.e. motion synchronisation between conveyor belt and robotic system.

In a passive conveying system, the robotic system can automatically remove the objects from the process line according to the invention, return them to the process line after processing and, if necessary, hit or push them back along the process line so that they then move along the process line again automatically.

The possibility, realised by the invention, that a robotic system with a compliance can guide an object in interaction with at least one guide means, makes it possible to form machining systems or work stations in which a corresponding robot is simply positioned in the area of a table or a workbench and the guide means are fixed stationary on the surface of the table accordingly. This allows machining systems or work stations to be manufactured in a wide variety of configurations for the intended applications, which are also particularly suitable for human-robot collaboration (HRC) working stations.

The invention also concerns, in a second aspect, a method for controlling a robotic system comprising at least one robot arm and a control unit for controlling the movement of the robot arm, comprising at least one effector, the robotic system having a compliance control and being positionable in the region of a process line along which an object or a carrier device on which the object is arranged is movable, the robot arm interacting with the object in the region of a working space associated with the robotic system, and the working space comprising at least one guide means for guiding the object or the carrier device, comprising the steps of:
processing the object using the effector; and
for the purpose of processing the object, guiding the object or the carrier device by means of the robot arm relative to the at least one guide means of the working space so that the object or the carrier device is automatically positioned in the correct position relative to the robotic system for processing; and/or
after processing of the object has been completed, guiding the object or the carrier device by the robot arm out of the guide means and thus out of the working space.

If the guide means are provided in the area of the process line and spaced apart, the step of guiding involves the robot arm pulling or pushing the object or carrier device between the guide means and thus along the process line.

If the guide means are off the process line, the step of guiding involves the robot arm returning the object or carrier device from the process line between two mutually converging guide means and/or from these guide means back to the process line.

In an embodiment of the method according to the invention, the step of guiding comprises:
connectionless contacting the object or the carrier device by means of the effector; and
applying a pull and/or push force or a corresponding torque to the object or to the carrier device by means of the effector.

In another embodiment of the method according to the invention, the step of guiding includes:
captively gripping the object or carrier device by means of the effector; and
applying a pull and/or push force to the object or to the carrier device by means of the effector, or
lifting the object or carrier device by means of the effector, transferring it to a working position and setting down the object or carrier device in this working position.

In other words, the method according to the invention, in which a robotic system according to the invention with a programmed compliance, if necessary, in combination with a defined force control, is used generally relates to the steps that the robotic system being located in the region of a production line pushes or pulls the workpiece to be machined, wherein machining can also be understood in the sense of contactless measurement or the like, from a position attainable for the robot arm of the robotic system, which is outside the nominal working space, to a defined position within its working space in interaction with the respective guide means provided there, wherein the working space can be located directly on the production line or next to it. The robotic system then performs the intended processing steps on the object. After completion of the process, if necessary again with the aid of the guide means, the robot arm pushes the workpiece back onto the process line or on it in the intended production direction, if necessary, to the next production station using its effector.

A particular advantage of the method according to the invention is that the control unit and the robot arm can also be designed in such a way that clocking during guidance of the object or the carrier device is specified exclusively by the robotic system itself.

The clocking specified by the robotic system basically allows the cycle times to be shortened, since the movement of the objects on the process line is decoupled from the processing steps carried out by the robotic system. Programming of the entire system and also the teach-in of the robotic system are considerably simplified.

Another significant advantage is that several different objects can be processed within one and the same process or production line, which do move in a random sequence. The robotic system can also be designed so that it can perform various actions on the object, depending on the object, whereby the robotic system is able to distinguish the objects from each other, e.g. by means of an appropriate external sensor system in real time or progression programming.

In order to define the trajectories when guiding the objects or the carrier devices, the respective starting position of the workpiece to be machined or carrier and the associated approach trajectory is stored by a user on the robotic system, taking into account the respective guide means directed to the nominal working space provided for this purpose, together with gripping or contact positions, preferably by means of a teach-in procedure. Furthermore, the end position of the workpiece in the area of the working space and the corresponding return trajectory are set on the robotic system.

This makes it easy for the robotic system to fetch the objects or workpieces or carrier devices carrying them to itself, so to speak, in order to carry out a previously programmed machining or working step.

Since the guide means actually guide the object in interaction with the movement of the robot or its individual axes, the movement paths to be traversed by the robotic system must not be defined with high precision, i.e. precisely position-controlled or regulated, or monitored and ensured by means of complex external sensors, such as image processing or tracking systems; rather, it is sufficient that these movement paths are stored or taught taking certain tolerances and deviations into account. The programming effort is thus considerably simplified.

In the case of a passive conveying system, in which the objects are to be moved along the extension of the process line, the robotic system always pulls or pushes the respective next object or the next carrier device through the robot arm and thereby automatically transports the previous, finally processed object or the corresponding carrier device to the next station on the process line. Alternatively, the robotic system can guide the machined workpiece itself to the next station, whereby the relevant trajectory must then also be stored by a user on the robotic system. In both cases, the final guidance of the object is always carried out by the guide means provided in the area of the process line.

In a third aspect, the invention concerns a processing system having a process line along which objects or carrier devices for these objects are movable, and a robot arranged in the region of this process line, the robot having one or more axes and being configured and designed with compliance control, and at least one guide means being provided which is arranged in the region of the process line and designed to transfer the object or the carrier device into a processing position intended for further processing of the object by a movement of the robot.

In an embodiment of the machining or processing system, the guiding means consists of spaced-apart guiding surfaces for the object or the carrier devices, the guiding surfaces being arranged along a process line which is linear or non-linear in design.

Since the movement, so to speak the drive of the objects along the process line takes place by means of a compliantly configured movement of the robot, but the actual guidance takes place via the guide means themselves, it is possible that the guide surfaces are arranged with a certain clearance to the object or the carrier device guided along the process line. This allows tolerance deviations in the dimensions of the objects to be compensated for, for example. The provision of a defined clearance or play also makes it possible and easier to program the movements the robot has to go through with certain deviations, i.e. with a certain amount of fuzziness.

A process line is a production line or line of any design on which objects to be processed can be moved continuously or discontinuously, if necessary between several working stations. However, the surface of a simple workbench is also conceivable, on which appropriate guide means are fixed, whereby the robot is simply positioned in the area of the table. In principle, a mobile robot can also be used for this purpose, which in itself cannot be positioned very precisely in relation to the table, but such inaccurate positioning of a mobile robot can be easily compensated for by combining compliance control with guide means in accordance with the invention.

It can also be a passive conveying system, e.g. several rollers on a slope, so that the objects move by their own weight, whereby in the area or in the proximity of the working space of the robotic system at least one stop means can be provided for the object or for the carrier device. The objects collide against the stop means and the robot arm removes the objects to be processed directly from there.

In a further embodiment of the machining system, at least one guide means may be provided in the area or outside, preferably directly next to the process line, for the object or for the carrier device.

In particular with an embodiment in which the nominal working space is outside the process line, two guide means may be provided which converge towards each other. The robot arm pulls the objects to be processed from the process line into the working space located between the two guide means. The converging design of the guide means, which can also be made of a flexible material in order to counter tolerance deviations, automatically positions the object or carrier device in the correct relative position or orientation to the robotic system. This further simplifies the requirements for programming the robotic system.

In a machining or processing system according to the invention, the working space and the process line are preferably located essentially on one level. However, it is also possible that these are located in different planes and the guide means is aligned transversely or at an angle to the plane of the process line. The guide means are formed by surfaces to be converged, between which the object is essentially inserted by the robot from above and can be centered downwards to the desired final position.

It becomes clear that the main advantages of the robotic system according to the invention on the one hand and a processing system implementing such a robotic system on the other hand lie in the fact that no special, in particular no spatially highly precise configuration and arrangement of the working space and the process line is required.

The flow or continuous processing devices or process lines can be completely passively designed independently of the processing steps to be carried out by the robotic system, which significantly reduces investment costs, since neither activated feed and discharge devices nor corresponding control of the locomotion have to be provided.

Due to the compliance, if necessary in combination with a programmable force control, of the robotic system according to the invention, it works quasi self-sufficiently in connection with a process line by specifying the clocking of the machining steps and the speed of the locomotion itself.

A major advantage of using a robotic system with compliance control, however, is that the guidance of objects to be processed along the process line as well as relative to a working space can only take place in interaction with guide means designed for this purpose and arranged at corresponding points. Since this eliminates the need for strict position control of the robot, no sensors are required to detect the individual positions of the objects or carrier devices as they move. An evaluation electronics/sensors and control system for this purpose can be completely omitted.

Further advantages and characteristics of the invention result from the description of the embodiments as shown in the attached figures, in which

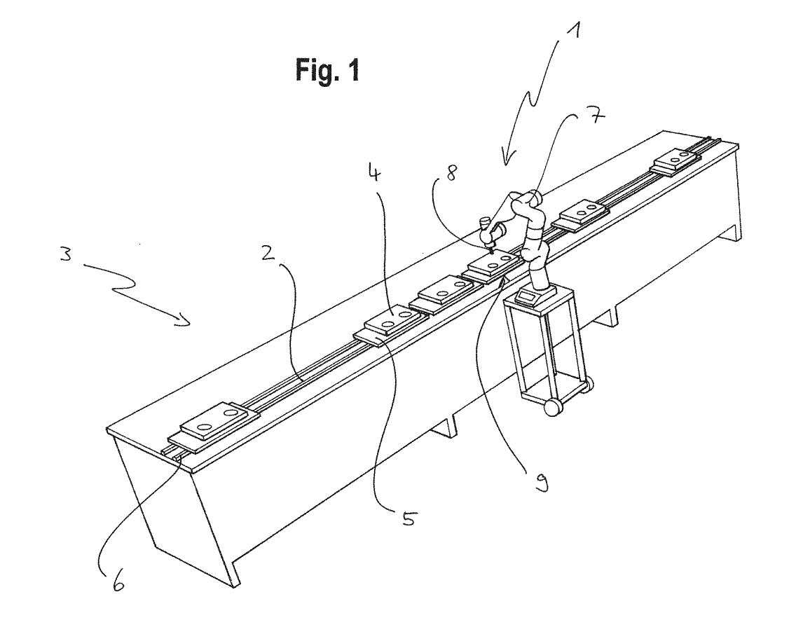

FIG. 1 exemplarily shows a perspective view of a robotic system at a known flow processing device;

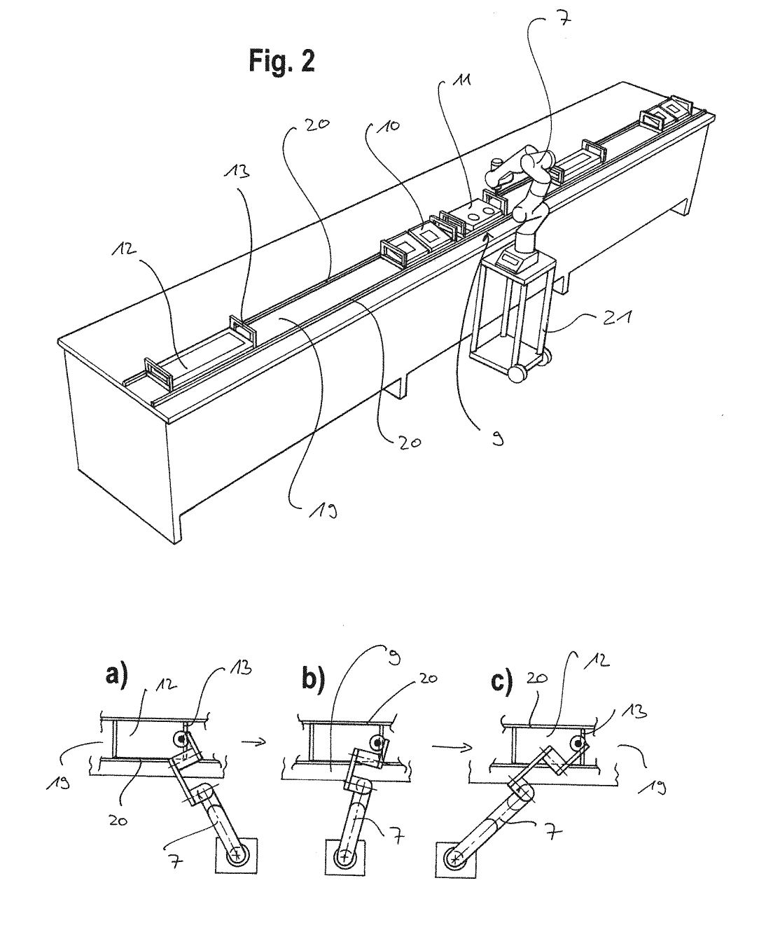

FIG. 2 shows a perspective view of a processing system with a robotic system in a first embodiment according to the invention;

FIGS. 2a,b,c are examples of different positions of a robot arm of the robotic system in the processing system from FIG. 2;

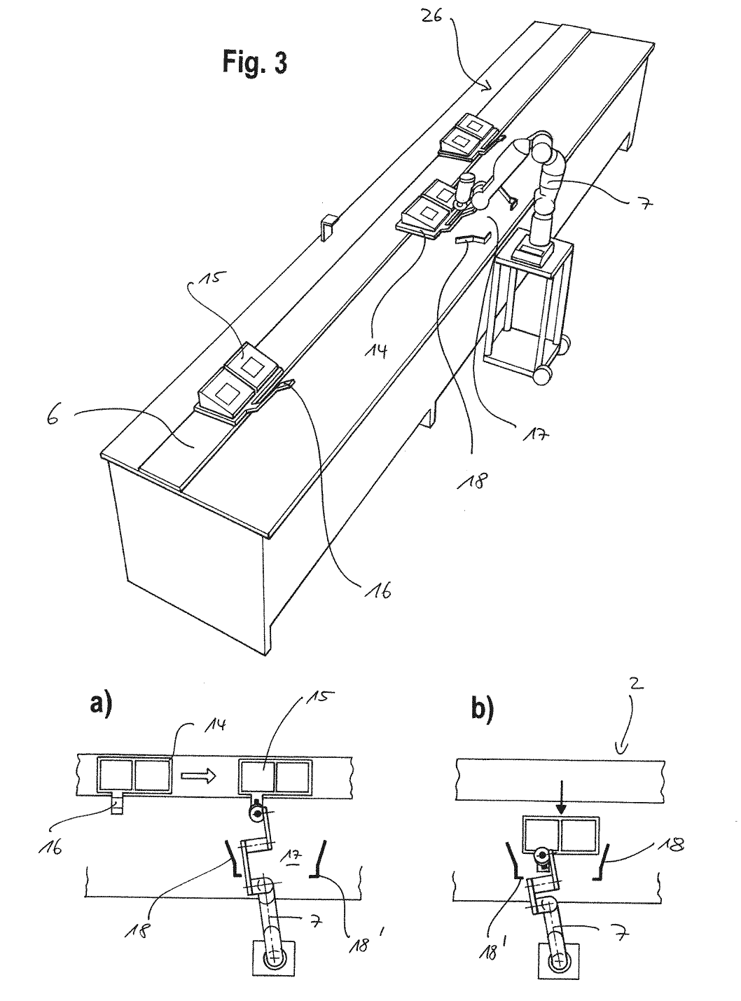

FIG. 3 is a perspective view of a processing system with a robotic system in a second embodiment according to the invention;

FIGS. 3a,b show examples of different positions of a robot arm of the robotic system according to the invention in the processing system from FIG. 3;

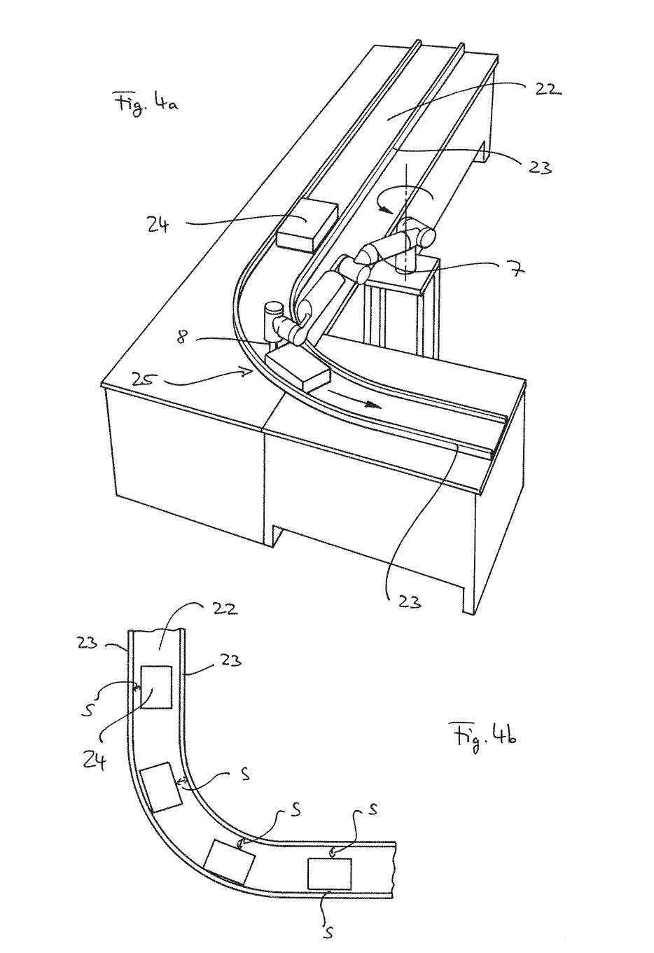

FIG. 4a is a perspective view of a processing system with a robotic system in a third embodiment according to the invention;

FIG. 4b is an example of a view from above of a process line from FIG. 4a; and

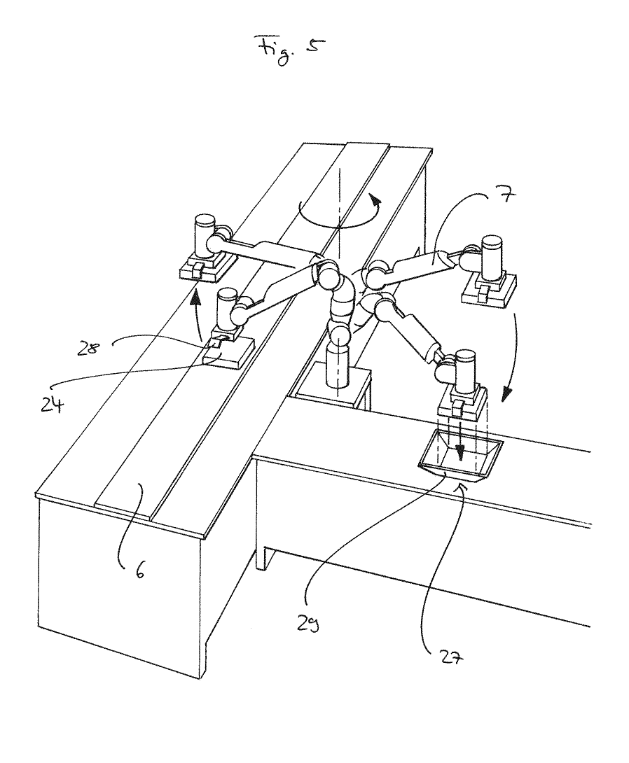

FIG. 5 is a perspective view of a processing system with a robotic system in a fourth embodiment according to the invention.

FIG. 1 shows an example of a state-of-the-art arrangement in which a robotic system 1, preferably of the lightweight design, is positioned on a process line 2 of a flow or non-interrupted processing device 3. Along process line 2, workpieces or objects 4, which are arranged on corresponding carrier devices 5, are moved past the robotic system 1 via an active conveyor belt 6.

The robotic system 1 has a multi-axis robot arm 7, which at its end carries an effector 8, e.g. a measuring pin, by means of which the robot arm 7 interacts in the area of a working space 9 assigned to robot arm 7, which is located directly in front of robotic system 1 on process line 2. Using the measuring pin 8, the robot arm 7 can scan object 4 for testing purposes, for example.

In this arrangement, object 4 is automatically moved past robotic system 1 by the actively driven conveyor belt 6. Since the conveyor belt 6 moves at a given speed, the cycle of the work processes for the robotic system 1 is ultimately determined by the speed of the conveyor belt 6. Accordingly, the movements of the robot arm 7 must be adjusted to the speed of the conveyor belt 6, while the time window for the machining steps to be carried out by the robot arm 7 remains limited.

FIG. 2, on the other hand, shows a machining/processing/working system in a first embodiment according to the invention, in which the robotic system 1 can set the cycle or clocking/timing itself.

Various objects 10, 11 are placed on corresponding carrier devices 12, which have a frame or handle 13 on the side.

Process line 19 is formed by two guide means in the form of guide surfaces 20 arranged at an equal distance from each other, between which the carrier devices 12 are movable along. The guide surfaces 20 serve as guide rails, so to speak, between which the carrier devices 12 are pulled or pushed along by the robot arm 7 engaging the handle 12 of the carrier device 12.

FIGS. 2a to c do show schematically in plan view different position states of the robotic system 1, preferably a mobile robot with a seven-axis robot arm or manipulator 7.

In FIG. 2a it is shown how the robot arm 7 with its effector 8 on process line 19 acts on a handle 13 of the carrier device 12 to the left of the nominal working space 9 in order to pull it into the nominal working space 9.

After the object on the carrier device 12 has been processed, which is not shown here, the effector 8 engages the handle 13 of the carrier device 12 again and pushes it further to the right on process line 2, as FIGS. 2b and 2c indicate. The robot arm 7 can then move back to the left again in order to come into contact with a next carrier device 12 and to pull it back into the area of the nominal working space 9 for machining and working purposes.

Because the robot arm 7 automatically pulls the carrier device along process line 2 into the nominal working space 9, which is arranged directly in front of the robotic system 1 in this case, and then automatically pushes the carrier device 12 out of the nominal working space 9 after processing, the cycle of the work steps to be performed by robotic system 1 is set automatically or the robotic system 1 determines the feed rate on process line 19 depending on the work steps to be performed.

Due to the resulting increased variability in the process steps, different objects 10 and 11 can be processed individually and, if necessary, differently with one and the same robotic system 1 within one and the same processing system and transported individually along process line 19.

Since, according to the invention the robot or robotic system 1 comprises a compliance control, the robot arm 7 only has to apply a pull or push force acting along process line 19 when the effector 8 engages with handle 13. In this case, the linear guidance of the carrier devices 12 is carried out exclusively by the two guide surfaces 20. This guidance function in interaction with the force to be applied by the robot arm 7 makes it perfectly sufficient that the effector 8 simply comes to rest on the side of handle 13.

Due to the fact that, in the absence of the need for position control and regulation for robotic system 1, it does not have to occupy a fixed, unchangeable position in space and in relation to process line 19, according to the invention the robotic system 1 can be easily positioned via a mobile platform 21 at an intended position relative to the nominal working space 9 and relative to process line 19. The position of robotic system 1 can therefore be adapted to altered machining processes without complicated retooling measures. Furthermore, it is possible that in such a processing system several such robotic systems 1 work together independently or synergistically on a process line 19, possibly even with the interposition of one or more workers. This allows any sequences to be designed for a machining system, e.g. specifically setting up production lines with HRC robotic systems. There are virtually no limits to the variability in the design and configuration of such processing systems according to the invention.

While FIG. 2 shows a processing system with an exclusively linear process line 19, FIG. 4a shows a processing system in a third embodiment according to the invention with a process line 22 that changes in the course. This process line 22 is also formed by two spaced guide rails or surfaces 23 within which objects 24 can be pushed along by the robot arm 7. Since robot arm 7 with its compliance control merely provides the feed for objects 24 by the effector 8 coming into contact with it laterally, it is possible that objects 24 can be guided around a curve 25 of process line 22 in interaction with the guide surfaces 23.

To prevent blocking, a certain clearance S is provided between the guide surfaces 23 and the dimensions of the objects 24, as shown in FIG. 4b. Robotic system 1 is therefore able to move objects 24 along process line 22 with a certain amount of vagueness across the direction of movement due to its control behaviour.

FIG. 3 shows another processing system in a second embodiment of the invention.

Along a process line 26, here again an active conveyor belt 6, carrier devices 14 move, on which the objects 15 to be processed are located. The carrier devices 14 comprise a handle element 16 on the front side.

Directly in front of the robotic system 1 is the nominal working space 17, which is limited by two guide means 18, which converge towards each other.

As can be seen schematically in FIGS. 3a and b, the robot arm 7 of the robotic system 1 according to the invention fetches the carrier device 14 from the conveyor belt 6 and pulls it into the working space 17 in front of it, whereby the converging guide means 18 automatically centers the carrier device 14 into a final working position, in that the carrier device 14 engages in the stops 18′ of the guide means 18 so that the robot arm 7 can then carry out the desired working steps without having to position the carrier device 14 with high precision, which facilitates its parameterization in advance.

After finishing the processing of objects 15, the robot arm 7 can push the carrier device 14 back onto the conveyor belt 6 by its effector 8 simply engaging the handle element 16.

The compliance control of the robot used according to the invention also allows the robotic system 1 to move the carrier devices 14 back and forth between the conveyor 6 and the working space 17, although the conveyor 6 and the working space 17 are not on a common plane.

FIG. 5 schematically shows a processing system in a fourth embodiment according to the invention. In it there is a nominal working space 27 further away from a conveyor belt 6, on which objects 24 move along. The effector of robotic system 1 is designed as a gripping mechanism 28, which can grip the objects 24. The robot arm 7 lifts the objects 24 and transfers them to the working space 27 by a rotary movement, illustrated by several positions of the robot arm 7. The working space 27 has a guide means in the form of a tapering funnel or hopper 29, into which the robot arm 7 inserts the object 24. The object 24 is then automatically centered in the final working or assembly position through the tapered walls of the hopper 29 as soon as the object 24 has been completely removed from the robot arm 7.

According to the invention, guidance along predetermined guide means, regardless of their design, is made possible by the fact that the robotic system, according to the invention, is inherently compliant with regard to the motor function or kinematics, which is further supported by the possibility, for example, of force, compliance or impedance control, or by a hybrid approach as a result of a combination of such different controls, of drive units in the individual joints between the links of the robot arm. This can take many forms. The most important are a control in joint coordinates, i.e. a coordinated axis control, or a task-oriented control, which is defined, for example, in Cartesian space, and are translated via geometric projections, such as, for example, by the Jacobi matrix, nominal joint torques or nominal joint forces. In addition, extensions such as multi-priority control could be used.

In interaction with specified guide means in the area of process lines, simple guidance of the objects by the robot can thus be realized.

The robotic system 1 according to the invention is also particularly suitable in environments in which people are simultaneously involved in the working processes of a flow processing device with this robotic system 1, so that such robotic systems 1 can be designed for a corresponding human-robot collaboration.

It becomes clear that the fact that, according to the invention, robotic system 1, which in itself goes beyond pure “pick and place” work steps and repetitive assembly steps, is intended to actively process objects, independently determines the timing of the individual work steps within a flow processing device, no limits are set to variability and flexibility, both with regard to the type of objects to be processed and the type of processing steps to be carried out on these objects.

The robotic system 1 according to the invention can be used individually for the respective intended purposes and programmed and parameterised accordingly, whereby the programming effort is lower, depending on the compliant design of the robotic system 1 as such. In particular, the aforementioned compliance control and force control with respect to the individual joints of the robot arm and thus of the robotic system 1 according to the invention with respect to its overall behavior can be used for this purpose.

1. Robotic system having at least one robot arm and a control unit for controlling the movement of the robot arm, which has at least one effector, the robotic system being positionable and orientable in the region of a process line along which an object or a carrier device, on which the object is arranged, can be moved, the control unit and the robot arm being configured such that
the robot arm can interact with the object in the region of a working space assigned to the robotic system such that the effector processes the object, and
the robot arm can guide the object or the carrier device into and/or out of the working space by means of the effector;
wherein the robotic system has a compliance control and the control unit is further configured such that the robot arm displaces the object or the carrier device relative to at least one guide means of the working space for guiding the object or the carrier device in such a way that the object or the carrier device is automatically positioned in the correct position relative to the robotic system for processing.

2. Robotic system according to claim 1, in which the working space is provided in the region of the process line and the control unit and the robot arm are configured such that the robot arm can guide the object or the carrier device along the process line between two mutually spaced guide means by means of the effector.

3. Robotic system according to claim 1, in which the working space is provided outside the process line and the control unit and the robot arm are configured such that the robot arm moves the object or the carrier device from the process line into the working space between two converging guide means and/or out of these guide means and thus back from the working space to the process line.

4. Robotic system according to claim 2, in which the control unit and the robot arm are configured such that the robot arm can apply a pull and/or push force to the object or to the carrier device by means of the effector.

5. Robotic system according to claim 1, in which the effector is configured such that it can cooperate with the object in the region of the working space without contact, forming a contact or changing the object.

6. Method for controlling a robotic system which has at least one robot arm and a control unit for controlling the movement of the robot arm, which has at least one effector, the robotic system having a compliance control and being positionable and orientable in the region of a process line, along which an object or a carrier device on which the object is arranged is movable, the robot arm interacting with the object in the region of a working space assigned to the robotic system, and the working space having at least one guide means for guiding the object or the carrier device,
comprising the steps of:
processing the object by means of the effector; and
for the purpose of processing the object, guiding the object or the carrier device by means of the robot arm relative to the at least one guide means of the working space in such a way that the object or the carrier device is automatically positioned in the correct position to the robotic system for processing; and/or
after the processing of the object has been completed, the object or the carrier device is guided out of the guide means and thus out of the working space by means of the robot arm.

7. Method according to claim 6, in which the guide means are provided in the region of the process line and are spaced from one another, the robot arm guiding the object or the carrier device between the guide means and thus along the process line.

8. Method according to claim 6, in which the robot arm guides the object or the carrier device from the process line between two mutually converging guide means and/or out of these guide means to the process line.

9. Method according to claim 6, in which the step of guiding comprises:
touching the object or the carrier device without connection by means of the effector; and
applying a pull and/or push force to the object or to the carrier device by means of the effector.

10. Method according to claim 6, in which the step of guiding comprises:
captively gripping the object or the carrier device by means of the effector; and
applying a pull and/or push force to the object or to the carrier device by means of the effector, or
lifting the object or the carrier device by means of the effector, transferring it into a working position and setting down the object or the carrier device in this working position.

11. Method according to claim 6, in which the control unit and the robot arm are configured in such a way that clocking is predetermined by the robotic system when the object or the carrier device is guided.

12. Processing system comprising a process line along which objects or carrier devices for these objects are movable, and a robot arranged in the region of said process line, said robot having one or more axes and being formed with compliance control, wherein at least one guide means arranged in the region of the process line and adapted to transfer the object or the carrier device by a movement of the robot into a processing position provided for further processing of the object.

13. Processing system according to claim 12, in which the guide means is formed of spaced-apart guide surfaces for the object or the carrier devices.

14. Processing system according to claim 13, in which the guide surfaces are arranged along a process line which is of linear or non-linear construction.

15. Processing system according to claim 14, in which the guide surfaces are arranged with clearance to the object guided along the process line or the carrier device.

15. Processing system according to claim 13, in which the guide surfaces are arranged in a working space located in the region of the process line or adjacent to the process line.

16. Processing system according to claim 15, in which the working space and the process line are substantially on one plane.

17. Processing system according to claim 15, in which the working space and the process line are in different planes and the guide means is aligned transversely or inclined to the plane of the process line.

18. Processing system according to claim 16 in which the guide surfaces converge to each other towards the intended machining position.

19. Processing system according to claim 12, in which the guide means are flexibly designed.

20. Processing system according to claim 12, in which the robot is a mobile robot.
